(19) United States
(12) Patent Application Publication
(10) Pub. No.: US 2025/0264004 A1
(43) Pub. Date: Aug. 21, 2025

(54) BALL-TYPE FLOW STOPPER INCLUDING A PRESSURE ACTIVATED CANTILEVER FEATURE

(71) Applicant: Halliburton Energy Services, Inc., Houston, TX (US)

(72) Inventors: Michael Reid, Aberdeen (GB); Liam Andrew Aitken, Aberdeen (GB); David O'Sullivan, Arbroath (GB)

(21) Appl. No.: 19/050,284

(22) Filed: Feb. 11, 2025

Related U.S. Application Data
(60) Provisional application No. 63/554,494, filed on Feb. 16, 2024.

(51) Int. Cl. F16K 39/06; E21B 34/06; F16K 5/06

(52) U.S. Cl. CPC F16K 39/06; E21B 34/06; F16K 5/0605; E21B 2200/04

(57) ABSTRACT

Provided is a ball-type flow stopper, a ball valve assembly, and a method. The ball-type flow stopper, in one aspect, includes a spherical contoured body, the spherical contoured body having a closed face, the closed face including a spherical seal area configured to engage with a valve seat of a ball valve assembly. The ball-type flow stopper, according to this aspect, further includes a flow port extending entirely through the spherical contoured body orthogonal with the closed face, and a slot extending into the closed face of the spherical contoured body to form a pressure activated cantilever feature, the slot beginning at a point inside of the spherical seal area. The ball-type flow stopper, according to this aspect, additionally includes a rotation support member extending from the spherical contoured body and aligned orthogonally to the flow port and the spherical seal area.

### CROSS-REFERENCE TO RELATED APPLICATION

This application claims the benefit of U.S. Provisional Application Ser. No. 63/554,494, filed on Feb. 16, 2024, entitled “BALL-TYPE FLOW STOPPER INCLUDING A PRESSURE ACTIVATED CANTILEVER FEATURE,” commonly assigned with this application and incorporated herein by reference in its entirety.

### BACKGROUND

Boreholes are drilled into subterranean formations to enable withdrawal and injection of fluids, such as hydrocarbon fluids in the case of withdrawal or injection fluids in the case of injection. During the drilling and production phases of hydrocarbon recovery, various procedures are performed that involve temporarily isolating fluid flowing into or out of the formation. Various types of valves, such as ball valve assemblies, may be deployed in a wellbore fluid flow control system and used during downhole operations to control the flow of fluid through one or more wellbore conduits. Ball valve assemblies generally include a ball seat for receiving a ball-type flow stopper having a flow port passing therethrough. The ball valve assembly is typically opened and closed in a quarter turn procedure, in which the flow port is either aligned with the fluid flow path (open position) or turned approximately 90°, such that one or both closed faces of the ball block fluid flow (closed position).

With the ball valve assembly in the closed position, fluid flow is blocked by a seal formed by the seating of a closed face of the ball-type flow stopper and the valve seat. A typical valve seat may comprise a ring surface that ideally makes close contact with the corresponding spherical seal area of the ball-type flow stopper. The seating is typically accomplished at least in part by seating actuation means, such as spring and/or hydraulic means that push, pull, or otherwise bias the valve seat toward the ball-type flow stopper to form the seal when the ball-type flow stopper is rotated to the closed position.

Ball valve assemblies are primarily employed as flow gates that either allow or prevent fluid flow. The structure of ball valve assemblies, for example in terms of material composition and configuration of constituent components (e.g., ball, valve seat) may have significant operational effects. For example, a metal-to-metal ball valve assembly configuration employs metal valve seats as well as a metal ball-type flow stopper, which create sealing surfaces of the ball valve assembly that are more resistant to damage by pressure transients during the valve open/close procedures.

### BRIEF DESCRIPTION

Reference is now made to the following descriptions taken in conjunction with the accompanying drawings, in which:

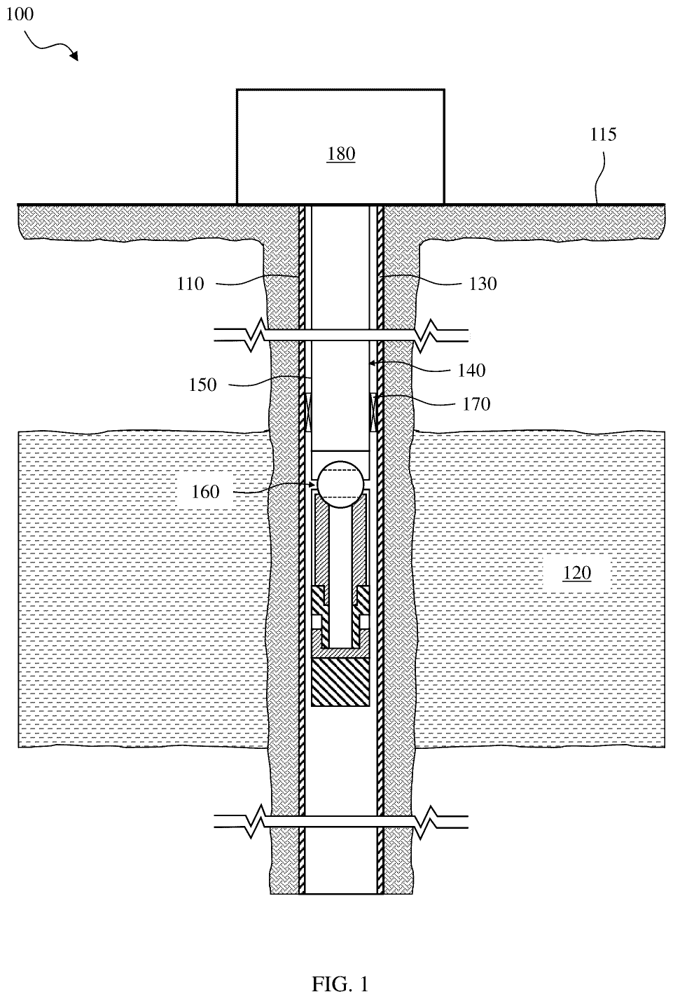

FIG. 1 illustrates a well system including an exemplary operating environment that the devices, apparatuses, systems, and methods disclosed herein may be employed;

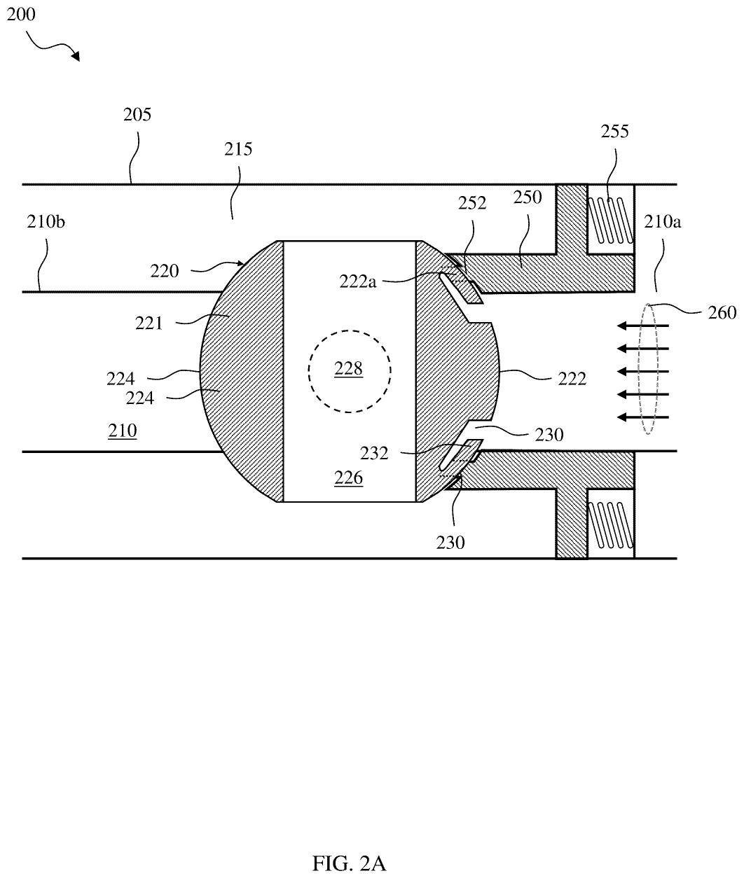

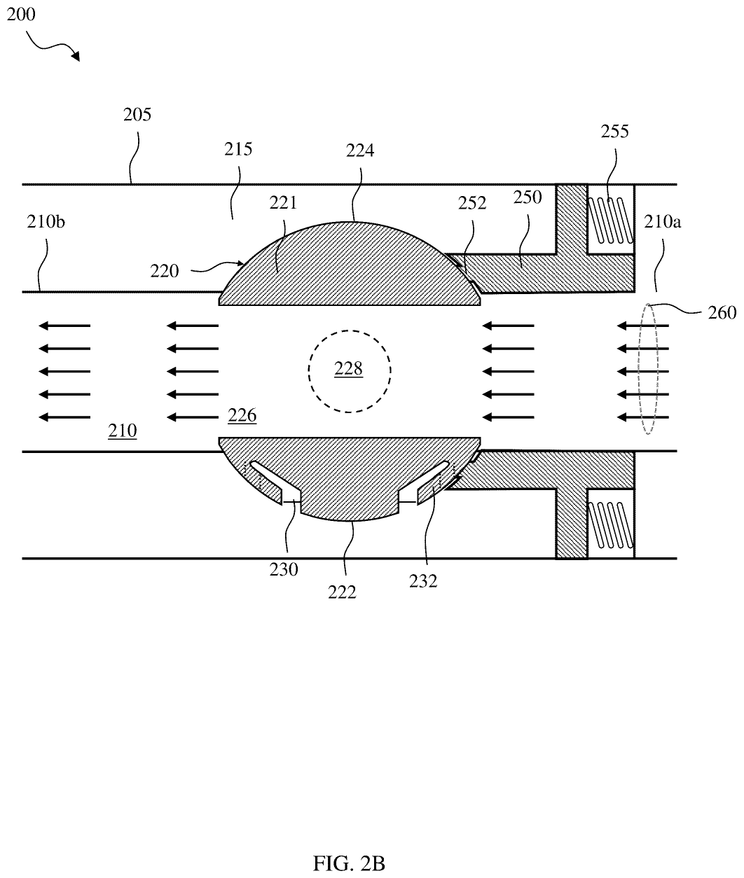

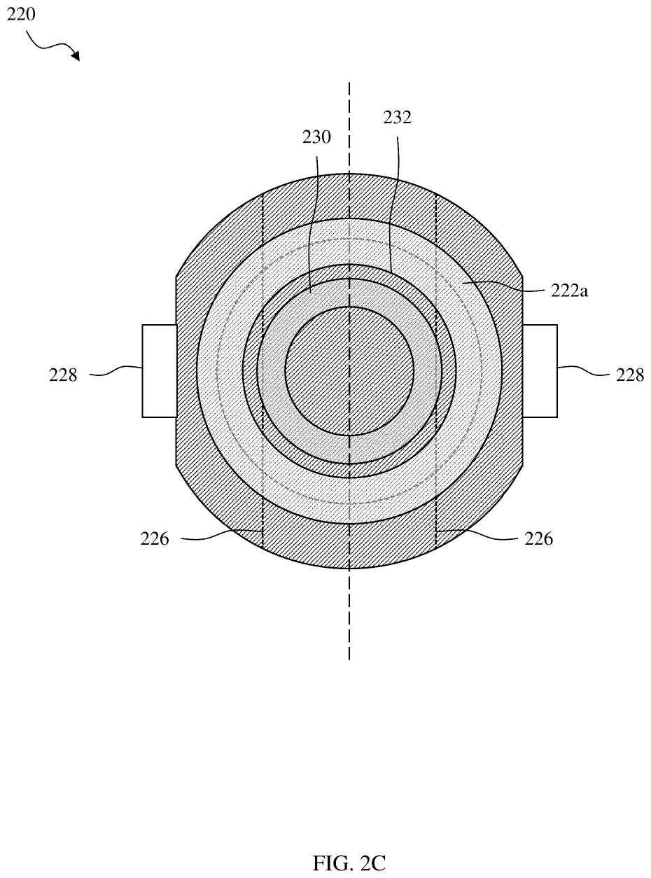

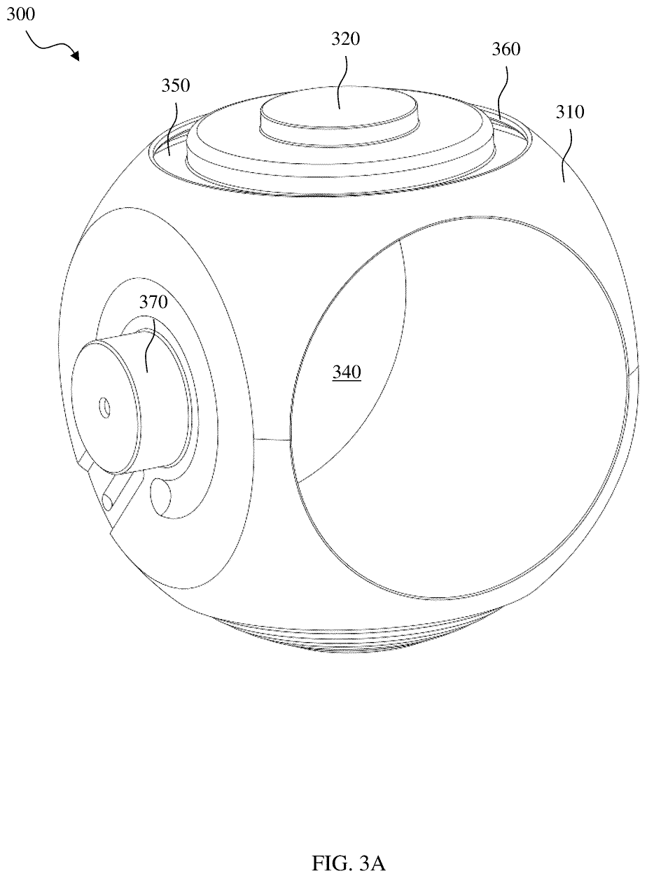

FIGS. 2A through 2C illustrate various different operational states of a ball valve assembly designed, manufactured and/or operated according to one or more embodiments of the disclosure;

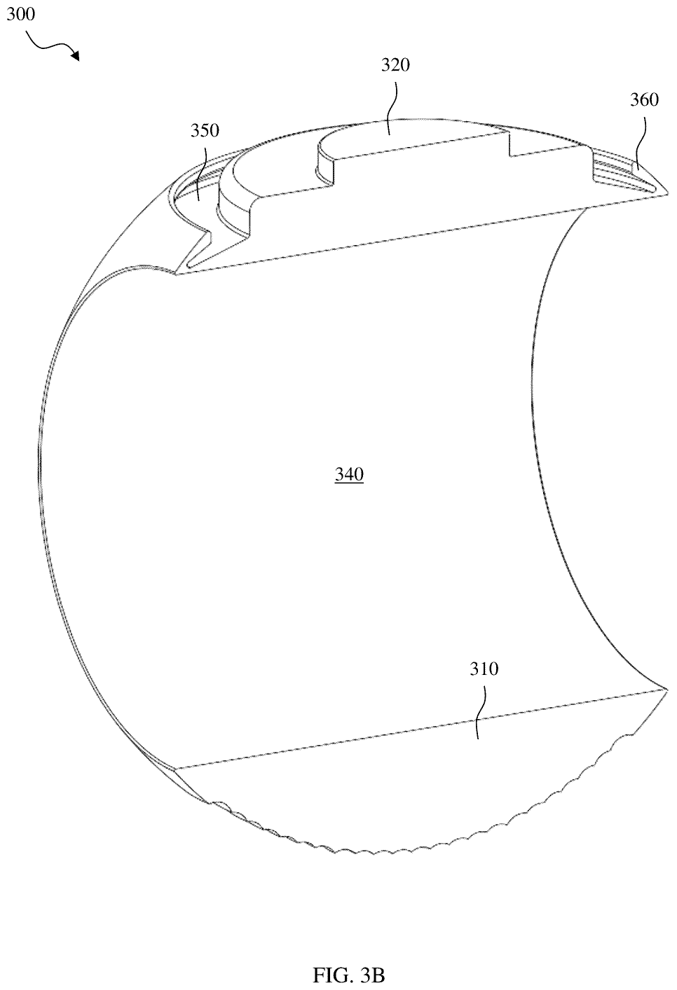

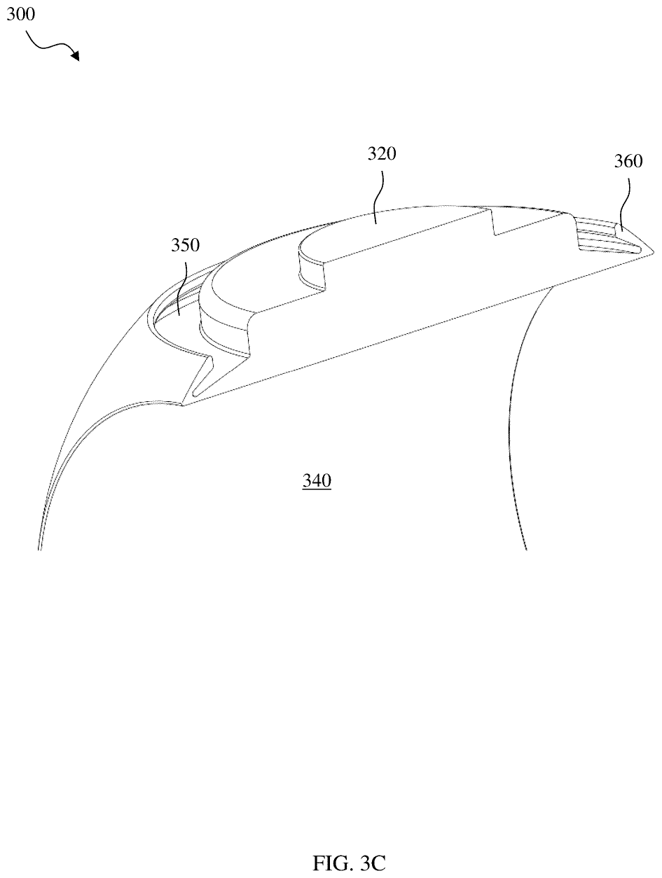

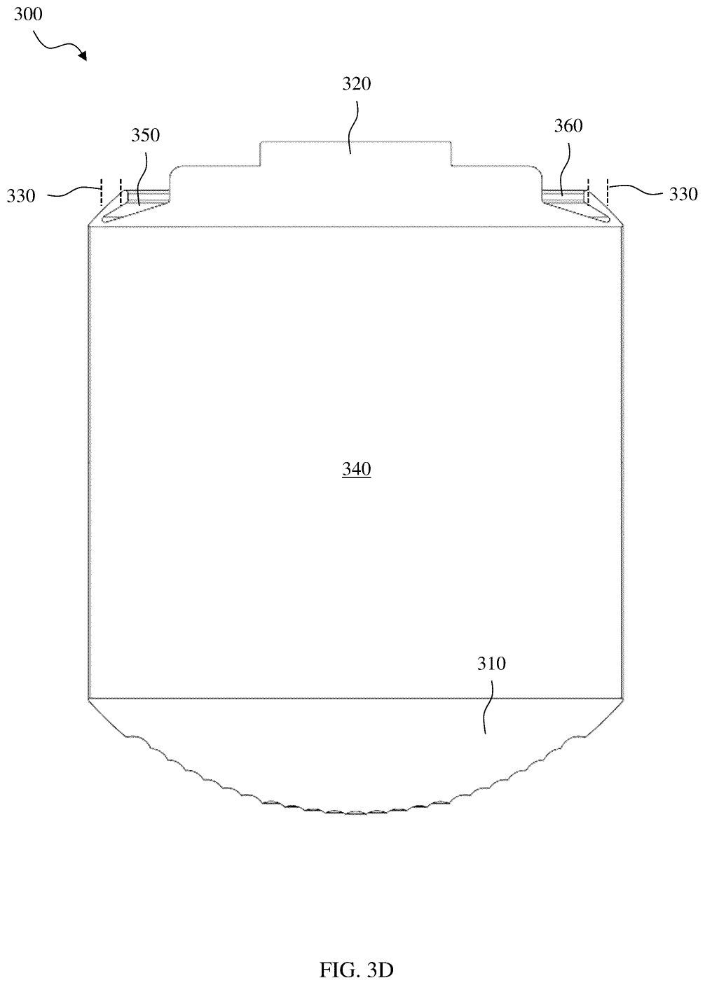

FIGS. 3A through 3D illustrate various different views of a ball-type flow stopper designed, manufactured and/or operated according to one or more embodiments of the disclosure;

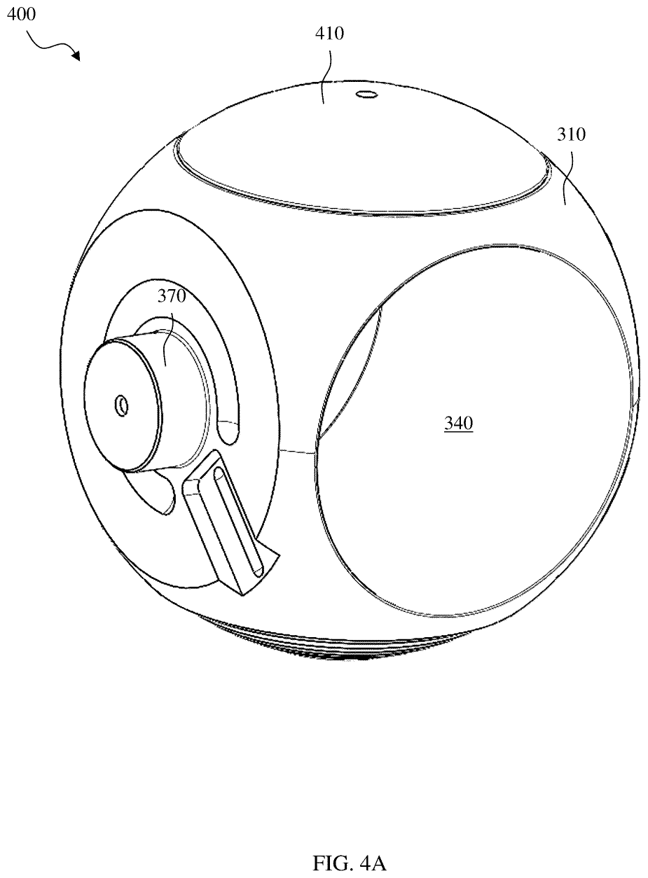

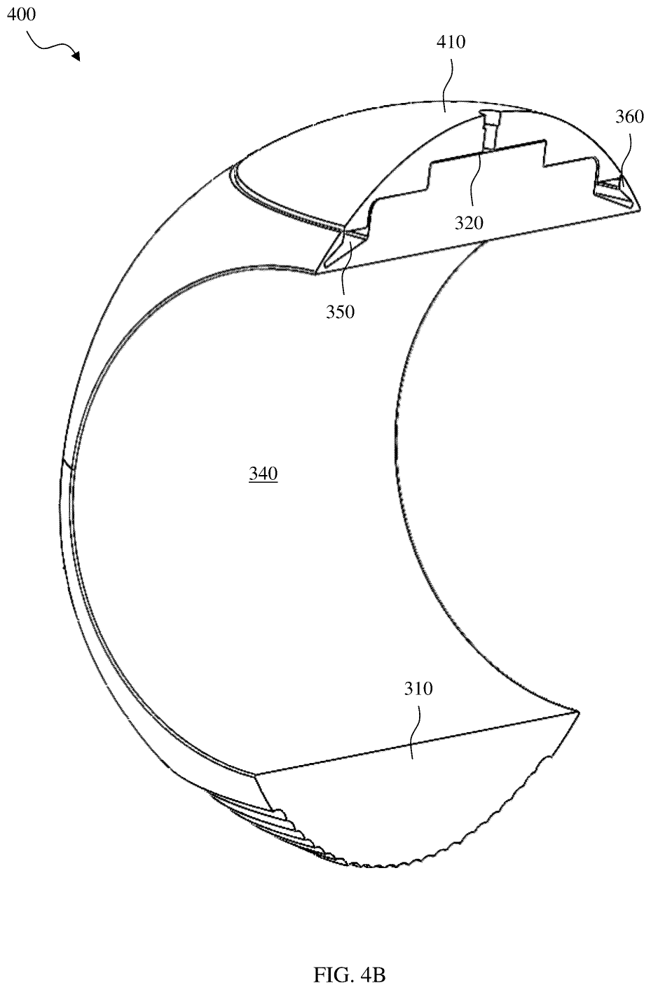

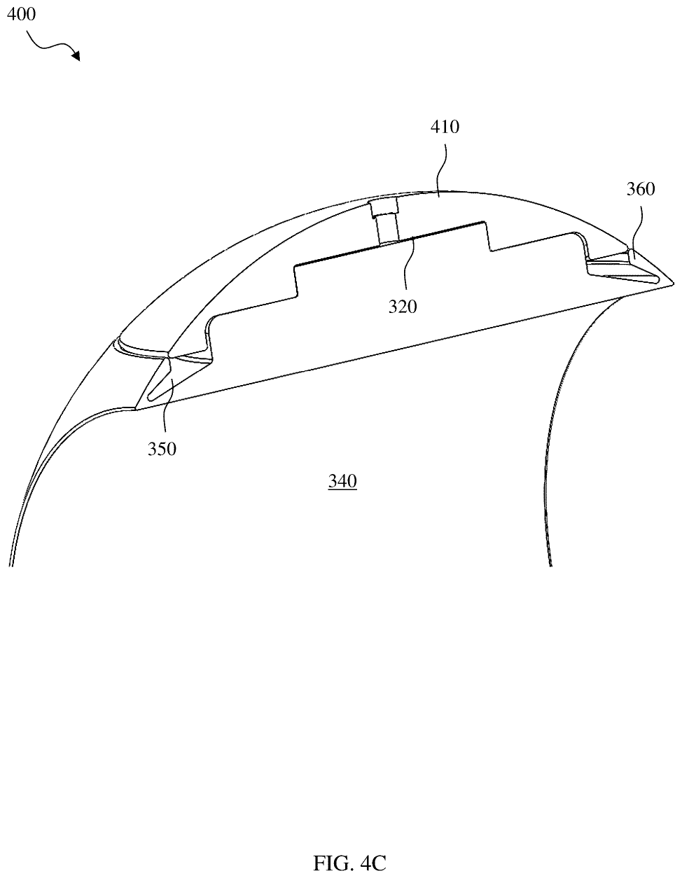

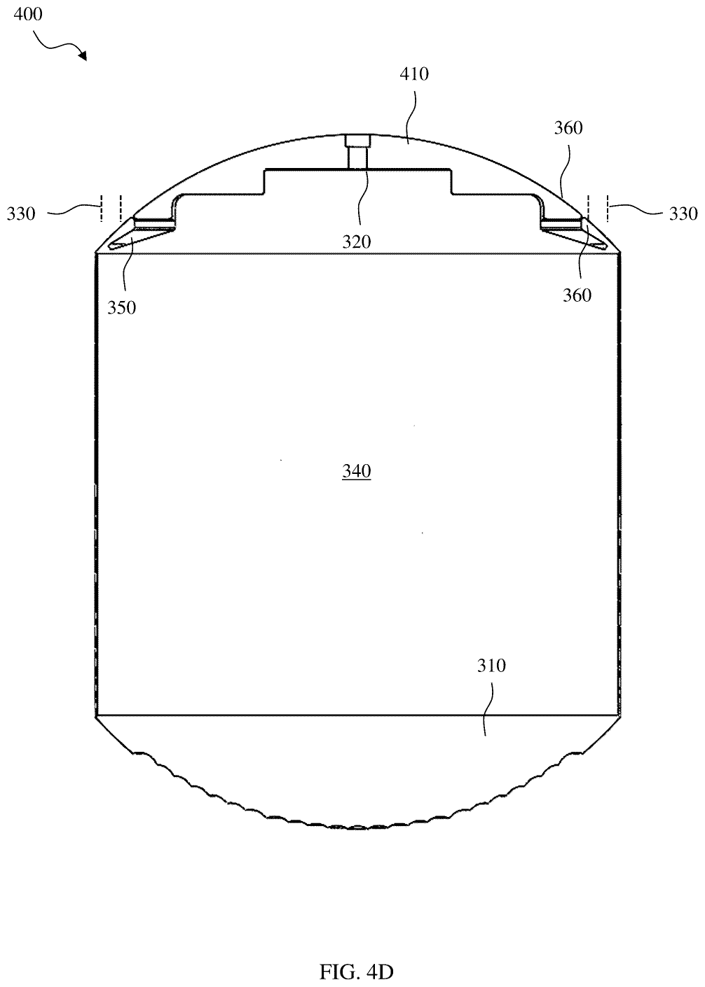

FIGS. 4A through 4D illustrate various different views of a ball-type flow stopper designed, manufactured and/or operated according to one or more alternative embodiments of the disclosure;

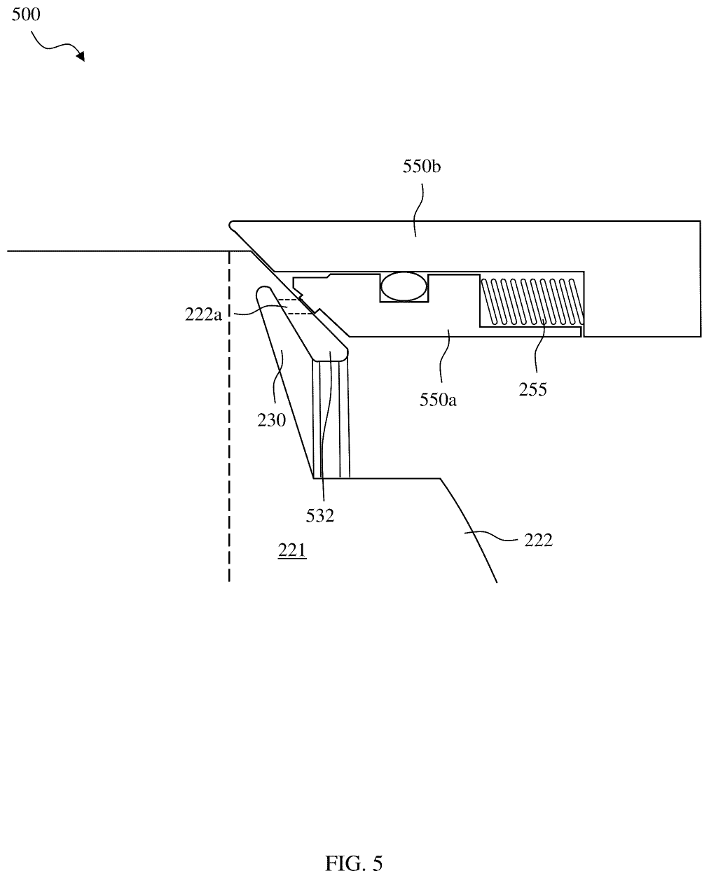

FIG. 5 illustrates a sectional view of a ball valve assembly designed, manufactured and/or operated according to one or more embodiments of the disclosure;

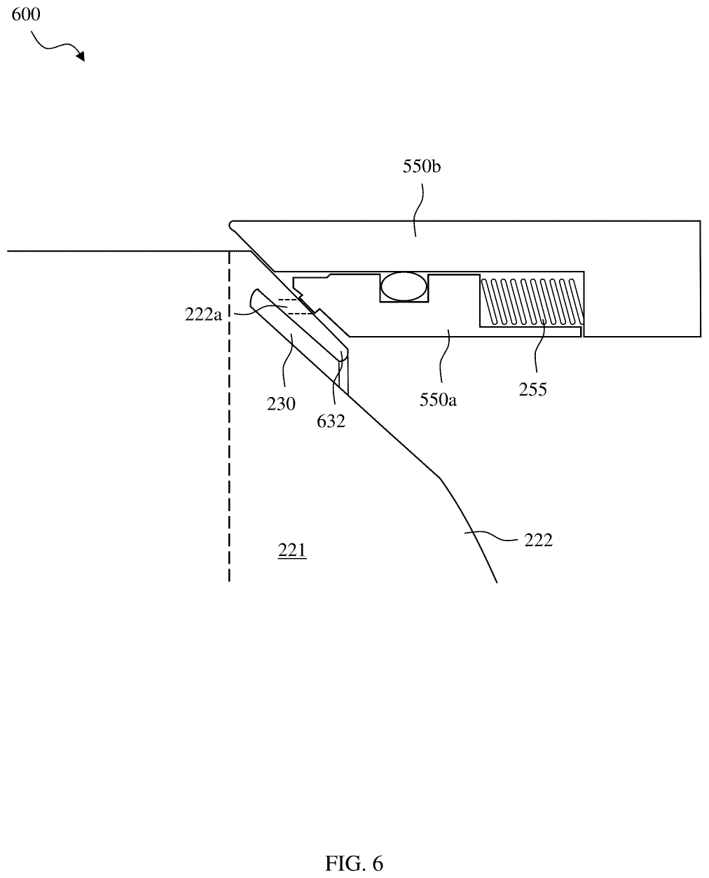

FIG. 6 illustrates a sectional view of a ball valve assembly designed, manufactured and/or operated according to one or more alternative embodiments of the disclosure; and

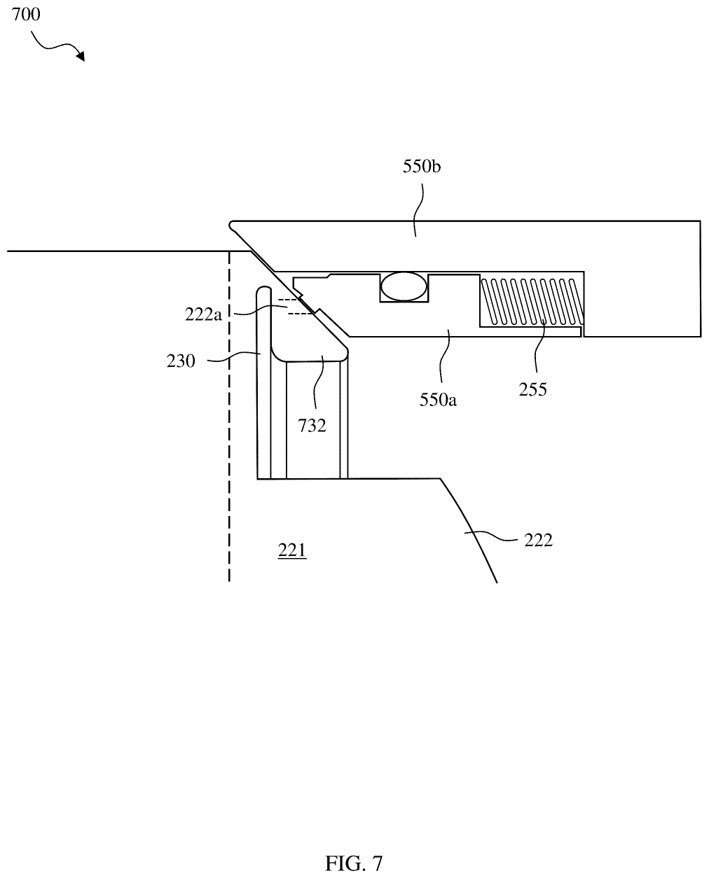

FIG. 7 illustrates a sectional view of a ball valve assembly designed, manufactured and/or operated according to one or more alternative embodiments of the disclosure.

### DETAILED DESCRIPTION

In the drawings and descriptions that follow, like parts are typically marked throughout the specification and drawings with the same reference numerals, respectively. The drawn figures are not necessarily to scale. Certain features of the disclosure may be shown exaggerated in scale or in somewhat schematic form and some details of certain elements may not be shown in the interest of clarity and conciseness. The present disclosure may be implemented in embodiments of different forms. Specific embodiments are described in detail and are shown in the drawings, with the understanding that the present disclosure is to be considered an exemplification of the principles of the disclosure, and is not intended to limit the disclosure to that illustrated and described herein. It is to be fully recognized that the different teachings of the embodiments discussed herein may be employed separately or in any suitable combination to produce desired results. Moreover, all statements herein reciting principles and aspects of the disclosure, as well as specific examples thereof, are intended to encompass equivalents thereof. Additionally, the term, “or,” as used herein, refers to a non-exclusive or, unless otherwise indicated.

Unless otherwise specified, use of the terms “connect,” “engage,” “couple,” “attach,” or any other like term describing an interaction between elements is not meant to limit the interaction to direct interaction between the elements and may also include indirect interaction between the elements described.

Unless otherwise specified, use of the terms “up,” “upper,” “upward,” “uphole,” “upstream,” or other like terms shall be construed as generally toward the surface of the subterranean formation, regardless of wellbore orientation; likewise, use of the terms “down,” “lower,” “downward,” “downhole,” “downstream,” or other like terms shall be construed as generally toward the bottom, terminal end of a well, regardless of the wellbore orientation. Use of any one or more of the foregoing terms shall not be construed as denoting positions along a perfectly vertical axis. Additionally, unless otherwise specified, use of the term “subterranean formation” shall be construed as encompassing both areas below exposed earth and areas below earth covered by water such as ocean or fresh water.

Various values and/or ranges are explicitly disclosed in certain embodiments herein. However, values/ranges from any lower limit may be combined with any upper limit to recite a range not explicitly recited. Similarly, values/ranges from any lower limit may be combined with any other lower limit to recite a range not explicitly recited. In the same way, values/ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited. Similarly, an individual value disclosed herein may be combined with another individual value or range disclosed herein to form another range.

The term “substantially XYZ,” as used herein, means that it is within 10 percent of perfectly XYZ. The term “significantly XYZ,” as used herein, means that it is within 5 percent of perfectly XYZ. The term “ideally XYZ,” as used herein, means that it is within 1 percent of perfectly XYZ. The monicker “XYZ” could refer to parallel, perpendicular, alignment, or other relative features disclosed herein.

The description and drawings included herein merely illustrate the principles of the disclosure. It will thus be appreciated that those skilled in the art will be able to devise various arrangements that, although not explicitly described or shown herein, embody the principles of the disclosure and are included within its scope.

The present disclosure is based, at least in part, on the acknowledgement that ball valve assemblies are commonly used downhole to act as a barrier. In many situations, it is preferable to use a metal-to metal (m-t-m) sealing interface between the ball-type flow stopper and the valve seat. This interface must be able to seal to specific industry standards (e.g., API 19V Annex F) so that the sealing interface will hold back differential pressure without leakage of gas (e.g., nitrogen) over a specified time period. The sealing interface must be capable of holding pressure in either direction (e.g., from above and below).

The present disclosure has recognized that due to the pressures involved, it is inevitable that the ball-type flow stopper will distort away from manufactured sphericity when there is an extremely high pressure differential applied across the ball-type flow stopper. The present disclosure has recognized that the ball-type flow stopper distortion is worst when pressure is applied below the ball-type flow stopper, for example as the ball-type flow stopper is deflected away from the valve seat (e.g., rather than when pressure is applied from above, which deflects the ball-type flow stopper into the valve seat). If the distortion on the ball-type flow stopper is excessive, the valve seat will struggle (e.g., or fail) to conform to the distorted shape and the sealing interface may be compromised.

Given the foregoing, the present disclosure has developed a ball valve assembly, and ball-type flow stopper, which reduces (e.g., alleviates) the excessive distortion between the ball-type flow stopper and the valve seat. In at least one embodiment, the ball valve assembly employs a ball-type flow stopper including a pressure activated cantilever feature to reduce the excess distortion. The present disclosure, in one or more embodiments, not only employs a pressure differential on the pressure activated cantilever feature to reduce the excess distortion, but the location of the cantilever feature also provides a mechanical advantage that advantageously reduces separation.

Accordingly, a ball valve assembly, for example designed, manufactured and/or operated according to the disclosure, includes a ball valve assembly including a ball-type flow stopper rotatable about a rotation axis. The ball-type flow stopper, in one or more embodiments, includes a spherical contoured body, the spherical contoured body having a closed face (e.g., a face upon which the high pressure fluid acts when the ball valve assembly is in its closed state), the closed face including a spherical seal area (e.g. spherical gas seal area, spherical fluid seal area, or a spherical gas/fluid seal area) configured to engage with a valve seat of a ball valve assembly. The ball-type flow stopper, in one or more embodiments, further includes a flow port extending entirely through the spherical contoured body orthogonal with the closed face. The ball-type flow stopper, in one or more embodiments, additionally includes a slot extending into the closed face of the spherical contoured body to form a pressure activated cantilever feature. To create the pressure activated cantilever feature, the slot begins at a point inside of the spherical seal area. Given this configuration, the higher pressure fluid surrounding the closed face extends within the slot and pushes the pressure active cantilever feature radially outward, for example against the valve seat of the ball valve assembly. Accordingly, the pressure activated cantilever feature may counteract the distortion of the spherical contoured body discussed above.

The cantilever aspect adds a surface that will deform somewhat independently from the bulk of the spherical contoured body itself, and will distort in a much more even way, making it easier for the valve seat to circumferentially conform to the spherical contoured body. The slot (e.g., machined-out profile) is deep enough, and positioned in such a way, that the pressure will act beyond the inner valve seat, causing a small section of pressure differential from below and above. This pressure differential causes the cantilever aspect of the profile to move ‘towards’ the valve seat, again adding to the ability for the valve seat to conform with the spherical contoured body.

Referring to FIG. 1, depicted is a well system 100 including an exemplary operating environment that the devices, apparatuses, systems, and methods disclosed herein may be employed. For example, the well system 100 could use one or more ball valve assemblies designed, manufactured and/or operated according to the disclosure. The illustrated well system 100 initially includes a wellbore 110. The wellbore 110, in the illustrated embodiment, extends from a terranean surface 115 to one or more subterranean formations 120 (e.g., hydrocarbon bearing geologic formations). In the illustrated embodiment, the wellbore 110 is a non-deviated wellbore. However, in other embodiments, the wellbore 110 could be a deviated wellbore, or alternatively could be a multilateral wellbore, without departing from the scope of the disclosure. While the well system 100 depicted in FIG. 1 is shown penetrating the terranean surface 115 on dry land, it should be understood that one or more of the apparatuses, systems and methods illustrated herein may alternatively be employed in other operational environments, such as within an offshore wellbore operational environment, for example, a wellbore penetrating subterranean formation beneath a body of water.

The well system 100, in the illustrated embodiment, includes wellbore casing 130 extending along at least a portion of the wellbore 110. Nevertheless, while the embodiment of FIG. 1 illustrates the wellbore 110 as being fully cased, other embodiments may exist wherein the wellbore 110 is only partially cased, or even an open-hole wellbore (e.g., does not include the wellbore casing 130), without departing from the scope of the present disclosure.

The well system 100, in the illustrated embodiment, additionally includes a wellbore tubular string 140 located within the wellbore 110. In the illustrated embodiment, the wellbore tubular string 140 includes a wellbore tubular 150, as well as a ball valve assembly 160 that has been designed, manufactured and/or operated according to one or more embodiments of the disclosure. In the embodiment of FIG. 1, the wellbore tubular string 140 is configured as a production tubing string, and thus includes one or more isolation packers 170 disposed within wellbore casing 130. The wellbore tubular string 140, including the ball valve assembly 160, is equally applicable to any type of wellbore tubular string installed within the wellbore 110. Example categories of wellbore tubular strings in which the ball valve assembly 160 may be installed include production tubing, drill pipe, casing, rod strings, and coiled tubing, among others.

In the illustrated embodiment of FIG. 1, the well system 100 additionally includes a well head 180 positioned on the terranean surface 115 over the wellbore 110. In the illustrated embodiment, the well head 180 is coupled with the wellbore tubular string 140. In one or more embodiments, the well head 180 includes various drilling and/or production related components, such as motors, winches and associated equipment, for positioning wellbore tubular string 140 within wellbore 110 and/or performing various operations relating to production and injection, among others.

In some embodiments, multiple ball valve assemblies, such as the ball valve assembly 160, may be deployed within wellbore 110 to control the flow of fluids within various zones of wellbore 110. In order to control the flow of a fluid within wellbore 110, the ball valve assembly 160 may be actuated from an open position (e.g., flow through position) to a closed position (e.g., flow stop position, as shown), and vice-versa, to selectively allow or prevent fluid flow to, from, and/or within wellbore tubular string 140.

While FIG. 1 depicts the ball valve assembly 160 deployed in a subterranean wellbore environment, other embodiments may utilize similar ball valves assemblies for other fluid flow control applications involving substantial differential pressures across the ball valve assembly. Such ball valve assemblies including the substantial differential pressures may occur in pipelines, refineries, chemical plants, manufacturing facilities, water treatment/storage/supply, etc., among others. Accordingly, the present disclosure should not be limited to any specific use for the ball valve assembly 160, and unless otherwise required should not be limited to oil and gas exploration applications (e.g., downhole applications).

Turning to FIGS. 2A and 2B, illustrated are various different operational states of a ball valve assembly 200 designed, manufactured and/or operated according to one or more embodiments of the disclosure. FIG. 2A illustrates the ball valve assembly 200 in a valve closed state, or stop flow state, whereas FIG. 2B illustrates the ball valve assembly in valve open state, or open flow state.

The ball valve assembly 200, in the illustrated embodiment, initially includes a valve body 205. The valve body 205, in the illustrated embodiment, includes a longitudinal opening 210 having a front flow side end 210a and a back trailing side end 210b. The longitudinal opening 210, in the illustrated embodiment, provides a path for fluids to flow through the ball valve assembly 200. In the illustrated embodiment, the valve body 205 further includes cavity 215, of which a ball-type flow stopper 220 designed, manufactured and/or operated according to one or more embodiments of the disclosure is located.

In the embodiment of FIG. 2A, the ball-type flow stopper 220, including a spherical contoured body 221, is in the valve closed position, in which a closed face 222 of ball-type flow stopper 220 is facing toward the front flow side end 210a (e.g., toward hydraulic pressure applied by a fluid 260 originating from a pressurized source (not depicted)), and a face 224 of the ball-type flow stopper 220 is facing toward the back trailing side end 210b (e.g., away from the hydraulic pressure applied by a fluid 260). In the embodiment of FIG. 2B, the ball-type flow stopper 220 is in the valve open position (e.g., has been rotated to the valve open position), in which the closed face 222 of the ball-type flow stopper 220 is substantially perpendicular to both the front flow side end 210a and the back trailing side end 210b, and the face 224 of the ball-type flow stopper 220 is substantially perpendicular to both the front flow side end 210a and the back trailing side end 210b. In yet another embodiment, the ball-type flow stopper 220 is in the valve open position (e.g., has been rotated to the valve open position), in which the closed face 222 of the ball-type flow stopper 220 is significantly perpendicular to both the front flow side end 210a and the back trailing side end 210b, and the face 224 of the ball-type flow stopper 220 is significantly perpendicular to both the front flow side end 210a and the back trailing side end 210b. In even yet another embodiment, the ball-type flow stopper 220 is in the valve open position (e.g., has been rotated to the valve open position), in which the closed face 222 of the ball-type flow stopper 220 is ideally perpendicular to both the front flow side end 210a and the back trailing side end 210b, and the face 224 of the ball-type flow stopper 220 is ideally perpendicular to both the front flow side end 210a and the back trailing side end 210b.

Ball-type flow stopper 220 may comprise the spherical contoured body 221 comprising a relatively hard and inelastic material, such as a stainless steel alloy. Orthogonal to closed faces 222 and 224, a flow port 226 is formed as a cylindrical passageway enabling fluid flow from the front flow side end 210a to the back trailing side end 210b when the ball valve assembly 200 is in the valve open position. The ball valve assembly 200, in one or more embodiments, can be moved between the closed position (e.g., FIG. 2A) and the open position (e.g., FIG. 2B) by rotating the ball-type flow stopper 220 about a rotation support member 228 that is aligned (e.g., orthogonally) to the flow port 226 and the closed faces 222 and 224. The rotation support member 228, in one or more embodiments, may comprise an attached or integral component to the ball-type flow stopper 220 and may be configured as an extending cylindrical hub that when secured within a suitable guide bearing (not depicted) provides linear position retention as well as enables rotation of the ball-type flow stopper 220.

In the depicted embodiment, the ball valve assembly 200 is a single seat valve comprising a valve seat 250 that is linearly actuated to press against the closed face 222 (e.g., flow side closed face) of the ball-type flow stopper 220. At the end of valve seat 250 is an annular seat surface 252 that is depicted as the curved end surface end of valve seat 250 that contacts the closed face 222. In at least one embodiment, the valve seat 250 is actuated by one or more springs 255 that apply a force that pushes the annular seating surface of valve seat 250 against a spherical seal area 222a on closed face 222. The contact between the annular seat surface 252 of valve seat 250 and the corresponding spherical seal area 222a provides a seal on the closed face 222 to prevent fluid leakage. While the embodiment of FIGS. 2A and 2B illustrate a single seat valve 250, aspects of the present disclosure are equally applicable to a multi seat valve, such as a valve including a radially inner seat and a radially outer seat.

FIGS. 2A and 2B illustrate components of the ball valve assembly 200 that directly or indirectly provide a fluid sealing function. While not depicted in FIGS. 2A and 2B, the ball valve assembly 200 may also include components (e.g., a threaded connection) located above or below ball valve assembly 200 to allow the ball valve assembly 200 to be disposed within and/or coupled to a wellbore tubular (e.g., of wellbore tubular string 140 in FIG. 1) and/or other wellbore components (e.g., production subs, downhole tools, screens, etc.), for example to form a workstring, production string, conveyance string, etc.

Referring to FIG. 2C in conjunction with FIG. 2A, in the depicted valve closed position, substantial pressure may be applied across the portion of closed face 222 within the circumferential boundary of spherical seal area 222a. The hydraulic pressure may be applied by the fluid 260. The pressure may be a varying pressure during rotation of ball-type flow stopper 220 to close and/or open ball valve assembly 200. With the ball valve assembly 200 in the closed position, pressure from springs 255 is applied via the seating surface 252 of valve seat 250 to spherical seal area 222a. In some embodiments, valve seat 250 may include alternate or additional linear actuation means such as a hydraulically controlled boost piston component. In such embodiments, the pressure applied by the seating surface of valve seat 250 may correspond to hydraulic pressure, such as hydraulic pressure from the front flow side end 210a.

The contact of the annular seating surface of valve seat 250 with spherical seal area 222a forms a ring shaped seal preventing fluid leakage at or proximate to closed face 222. Given the considerable fluid pressures that may be encountered in some applications, the contact between the seating surface of valve seat 250 and spherical seal area 222a must be relatively uniform such that there are no significant gaps in the resultant seal. Some ball valves use elastic materials such as polymers to provide closer and more uniform contact to form the seal. However, some fluid flow control applications, such as controlling flows of downhole fluids in a well system, entail environmental conditions that require harder and less elastic materials be used to form the ball valve seals. For example, downhole flow control environments may include high hydraulic pressures applied that may result in pressure transients during the closing and/or opening of a ball valve that may damage softer and/or relatively clastic materials.

Metal-to-metal (m-t-m) seating may be used in which the annular seating surface 252 of valve seat 250 and the closed face 222 of the ball-type flow stopper 220 both comprise relatively hard and inelastic metals or metallic alloys. Such m-t-m ball valve assembly configurations may locate the valve seat on the flow side end of the ball valve assembly 200 to avoid sealing discontinuities that may result from debris fallout that may accumulate on the back trailing side end of the ball valve assembly 200 and the ball-type flow stopper when the ball valve assembly 200 is closed (e.g., as depicted in FIG. 2A). However, a m-t-m ball valve assembly, such as the ball valve assembly 200, may be subject to pressure effects that may alter the surface contour of the closed face 222, resulting in contact gaps that compromise the seal between the annular seating surface 252 of valve seat 250 and spherical seal area 222a.

To counteract these pressure effects, the ball-type flow stopper 220 includes a slot 230 located in the spherical contoured body 221. The slot 230, in the illustrated embodiment, extends into the closed face 222 of the spherical contoured body 221 to form a pressure activated cantilever feature 232. The slot 230, in one or more embodiments, beginning at a point inside of the spherical seal area 222a. Accordingly, an opening 230a of the slot 230 is located radially inside of the spherical seal area 222a, and thus may be subject to the fluid pressure from the fluid 260 when the ball valve assembly 200 is in its closed position.

In one or more embodiments, the slot 230 ends at a point at least 10 percent under the spherical seal area 222a, as shown in FIG. 2A. In yet another embodiment, the slot 230 ends at a point at least 25 percent under the spherical seal area 222a. In even yet another embodiment, the slot 230 ends at a point at least 50 percent, if not at least 75 percent, under the spherical seal area 222a. In another embodiment, the slot 230 extends entirely under the spherical seal area, if not entirely under and outside of the spherical seal area 222a.

The ball-type flow stopper 220 according to the disclosure benefits from the ability of the fluid pressure to extend into the slot 230 and under the pressure activated cantilever feature 232. Again, the pressure acts upon the pressure activated cantilever feature 232 to force the pressure activated cantilever feature 232 against the valve seat annular seating surface 252 of valve seat 250. The ball-type flow stopper 220, according to the present disclosure, also mechanically benefits from the slot, as the removed slot allows for more uniform distortion of the spherical contoured body 221.

Turning to FIGS. 3A through 3D, illustrated are various different views of a ball-type flow stopper 300 designed, manufactured and/or operated according to one or more embodiments of the disclosure. The ball-type flow stopper 300, in the illustrated embodiment, includes a spherical contoured body 310. The spherical contoured body 310, in the illustrated embodiment, has a closed face 320. The closed face 320, in this embodiment, includes a spherical seal area 330 configured to engage with a valve seat of a ball valve assembly.

The ball-type flow stopper 300, in the illustrated embodiment, further includes a flow port 340 extending entirely through the spherical contoured body 310, for example orthogonal with the closed face 320. The ball-type flow stopper 300 further includes a slot 350 extending into the closed face 320 of the spherical contoured body 310 to form a pressure activated cantilever feature 360. In accordance with one embodiment, the slot 350 begins at a point inside of the spherical seal area 330. The ball-type flow stopper 300, in the illustrated embodiment, further includes a rotation support member 370 extending from the spherical contoured body 310 and aligned orthogonally to the flow port 340 and the fluid seal area 330.

Turning to FIGS. 4A through 4D, illustrated are various different views of a ball-type flow stopper 400 designed, manufactured and/or operated according to one or more embodiments of the disclosure. The ball-type flow stopper 400 of FIGS. 4A through 4D is similar in many respects to the ball-type flow stopper 300 of FIGS. 3A through 3D. Accordingly, like reference numbers have been used to indicate similar, if not identical, features. The ball-type flow stopper 400 differs, for the most part, from the ball-type flow stopper 300, in that the ball-type flow stopper 400 includes a flow stopper cap 410 physically covering the slot 350. In this embodiment, however, the flow stopper cap 410 does not fluidically seal the slot 350, but allows the pressurized fluid to enter the slot 350 and advantageously act upon the pressure activated cantilever feature 360 when the ball-type flow stopper 400 is in its closed state. The flow stopper cap 410 may couple with the spherical contoured body 310 in a number of different ways. Nevertheless, in one embodiment, one or both of the flow stopper cap 410 or the spherical contoured body 310 includes threads for coupling the two together.

Turning to FIG. 5, illustrated is a sectional view of a ball valve assembly 500 designed, manufactured and/or operated according to one or more embodiments of the disclosure. The ball valve assembly 500 of FIG. 5 is similar in many respects to the ball valve assembly 200 of FIG. 2. Accordingly, like reference numbers have been used to indicate similar, if not identical, features. The ball valve assembly 500 differs, for the most part, from the ball valve assembly 200, in that the ball valve assembly 500 includes a first valve seat 550a and a second valve seat 550b, as opposed to the single valve seat 250 of FIGS. 2A and 2B. Furthermore, the ball valve assembly 500 includes a pressure activated cantilever feature 532 that has a non-uniform cross-sectional shape (e.g., pressure activated cantilever feature 232 of FIG. 2).

Turning to FIG. 6, illustrated is a sectional view of a ball valve assembly 600 designed, manufactured and/or operated according to one or more embodiments of the disclosure. The ball valve assembly 600 of FIG. 6 is similar in many respects to the ball valve assembly 500 of FIG. 5. Accordingly, like reference numbers have been used to indicate similar, if not identical, features. The ball valve assembly 600 differs, for the most part, from the ball valve assembly 500, in that the ball valve assembly 600 includes a pressure activated cantilever feature 632 that has a uniform cross-sectional shape (e.g., as opposed to the non-uniform cross-sectional shape of FIG. 5).

Turning to FIG. 7, illustrated is a sectional view of a ball valve assembly 700 designed, manufactured and/or operated according to one or more embodiments of the disclosure. The ball valve assembly 700 of FIG. 7 is similar in many respects to the ball valve assembly 500 of FIG. 5. Accordingly, like reference numbers have been used to indicate similar, if not identical, features. The ball valve assembly 700 differs, for the most part, from the ball valve assembly 500, in that the ball valve assembly 700 includes a different shaped pressure activated cantilever feature 732.

Aspects disclosed herein include:
A. A ball-type flow stopper, the ball-type flow stopper including: 1) a spherical contoured body, the spherical contoured body having a closed face, the closed face including a spherical seal area configured to engage with a valve seat of a ball valve assembly; 2) a flow port extending entirely through the spherical contoured body orthogonal with the closed face; 3) a slot extending into the closed face of the spherical contoured body to form a pressure activated cantilever feature, the slot beginning at a point inside of the spherical seal area; and 4) a rotation support member extending from the spherical contoured body and aligned orthogonally to the flow port and the spherical seal area.
B. A ball valve assembly, the ball valve assembly including: 1) a valve body, the valve body including a cavity; and 2) a ball-type flow stopper located within and configured to rotate within the cavity of the valve body, the ball-type flow stopper including: a) a spherical contoured body, the spherical contoured body having a closed face, the closed face including a spherical seal area configured to engage with a valve seat of a ball valve assembly; b) a flow port extending entirely through the spherical contoured body orthogonal with the closed face; c) a slot extending into the closed face of the spherical contoured body to form a pressure activated cantilever feature, the slot beginning at a point inside of the spherical seal area; and d) a rotation support member extending from the spherical contoured body and aligned orthogonally to the flow port and the spherical seal area.
C. A method, the method including: 1) positioning a ball valve assembly within a wellbore extending through one or more subterranean formations, the ball valve assembly including: a) a valve body, the valve body including a cavity; b) a ball-type flow stopper located within and configured to rotate within the cavity of the valve body, the ball-type flow stopper including: i) a spherical contoured body, the spherical contoured body having a closed face, the closed face including a spherical seal area configured to engage with a valve seat of a ball valve assembly; ii) a flow port extending entirely through the spherical contoured body orthogonal with the closed face; iii) a slot extending into the closed face of the spherical contoured body to form a pressure activated cantilever feature, the slot beginning at a point inside of the spherical seal area; and iv) a rotation support member extending from the spherical contoured body and aligned orthogonally to the flow port and the spherical seal area; and 2) rotating the ball-type flow stopper between a closed state and an open state.

Aspects A, B, and C may have one or more of the following additional elements in combination: Element 1: wherein the slot ends at a point at least 10 percent under the spherical seal area. Element 2: wherein the slot ends at a point at least 25 percent under the spherical seal area. Element 3: wherein the slot ends at a point at least 50 percent under the spherical seal area. Element 4: wherein the slot ends at a point at least 75 percent under the spherical seal area. Element 5: wherein the slot extends entirely under the spherical seal area. Element 6: wherein the slot extends entirely under and outside of the spherical seal area. Element 7: wherein the pressure activated cantilever feature has a uniform cross-sectional shape. Element 8: wherein the pressure activated cantilever feature has a non-uniform cross-sectional shape. Element 9: further including a flow stopper cap physically covering but not fluidically scaling the slot.

Those skilled in the art to which this application relates will appreciate that other and further additions, deletions, substitutions and modifications may be made to the described embodiments.

What is claimed is:

1. A ball-type flow stopper, comprising:
a spherical contoured body, the spherical contoured body having a closed face, the closed face including a spherical seal area configured to engage with a valve seat of a ball valve assembly;
a flow port extending entirely through the spherical contoured body orthogonal with the closed face;
a slot extending into the closed face of the spherical contoured body to form a pressure activated cantilever feature, the slot beginning at a point inside of the spherical seal area; and
a rotation support member extending from the spherical contoured body and aligned orthogonally to the flow port and the spherical seal area.

2. The ball-type flow stopper as recited in claim 1, wherein the slot ends at a point at least 10 percent under the spherical seal area.

3. The ball-type flow stopper as recited in claim 1, wherein the slot ends at a point at least 25 percent under the spherical seal area.

4. The ball-type flow stopper as recited in claim 1, wherein the slot ends at a point at least 50 percent under the spherical seal area.

5. The ball-type flow stopper as recited in claim 1, wherein the slot ends at a point at least 75 percent under the spherical seal area.

6. The ball-type flow stopper as recited in claim 1, wherein the slot extends entirely under the spherical seal area.

7. The ball-type flow stopper as recited in claim 1, wherein the slot extends entirely under and outside of the spherical seal area.

8. The ball-type flow stopper as recited in claim 1, wherein the pressure activated cantilever feature has a uniform cross-sectional shape.

9. The ball-type flow stopper as recited in claim 1, wherein the pressure activated cantilever feature has a non-uniform cross-sectional shape.

10. The ball-type flow stopper as recited in claim 1, further including a flow stopper cap physically covering but not fluidically sealing the slot.

11. A ball valve assembly, comprising:
a valve body, the valve body including a cavity; and
a ball-type flow stopper located within and configured to rotate within the cavity of the valve body, the ball-type flow stopper including:
a spherical contoured body, the spherical contoured body having a closed face, the closed face including a spherical seal area configured to engage with a valve seat of a ball valve assembly;
a flow port extending entirely through the spherical contoured body orthogonal with the closed face;
a slot extending into the closed face of the spherical contoured body to form a pressure activated cantilever feature, the slot beginning at a point inside of the spherical seal area; and
a rotation support member extending from the spherical contoured body and aligned orthogonally to the flow port and the spherical seal area.

12. The ball valve assembly as recited in claim 11, wherein the slot ends at a point at least 10 percent under the spherical seal area.

13. The ball valve assembly as recited in claim 11, wherein the slot ends at a point at least 25 percent under the spherical seal area.

14. The ball valve assembly as recited in claim 11, wherein the slot ends at a point at least 50 percent under the spherical seal area.

15. The ball valve assembly as recited in claim 11, wherein the slot ends at a point at least 75 percent under the spherical seal area.

16. The ball valve assembly as recited in claim 11, wherein the slot extends entirely under the spherical seal area.

17. The ball valve assembly as recited in claim 11, wherein the slot extends entirely under and outside of the spherical seal area.

18. The ball valve assembly as recited in claim 11, wherein the pressure activated cantilever feature has a uniform cross-sectional shape.

19. The ball valve assembly as recited in claim 11, wherein the pressure activated cantilever feature has a non-uniform cross-sectional shape.

20. The ball valve assembly as recited in claim 11, further including a flow stopper cap physically covering but not fluidically sealing the slot.

21. A method, comprising:
positioning a ball valve assembly within a wellbore extending through one or more subterranean formations, the ball valve assembly including:
a valve body, the valve body including a cavity;
a ball-type flow stopper located within and configured to rotate within the cavity of the valve body, the ball-type flow stopper including:
a spherical contoured body, the spherical contoured body having a closed face, the closed face including a spherical seal area configured to engage with a valve seat of a ball valve assembly;
a flow port extending entirely through the spherical contoured body orthogonal with the closed face;
a slot extending into the closed face of the spherical contoured body to form a pressure activated cantilever feature, the slot beginning at a point inside of the spherical seal area; and
a rotation support member extending from the spherical contoured body and aligned orthogonally to the flow port and the spherical seal area; and
rotating the ball-type flow stopper between a closed state and an open state.
